(19) United States
(12) Patent Application Publication
(10) Pub. No.: US 2016/0019669 A1
(43) Pub. Date: Jan. 21, 2016

(54) ONLINE PEOPLE DEPUTATION SYSTEM

(71) Applicant: RANJITH GOPALAKRISHNAN, BENTONVILLE, AR (US)

(72) Inventor: RANJITH GOPALAKRISHNAN, BENTONVILLE, AR (US)

(21) Appl. No.: 14/817,738

(22) Filed: Aug. 4, 2015

(51) Int. Cl. G06Q 50/30; G06Q 50/00; G06Q 10/08; G06Q 30/06; G06Q 10/02

(52) U.S. Cl. CPC G06Q 50/30; G06Q 30/0611; G06Q 10/02; G06Q 10/08345; G06Q 50/01

(57) ABSTRACT

A method and system of deputizing people for transportation needs in a social networking model through an online people deputation system comprising of updating a calendar entry of people for person, package and project travel services listing, balancing the supply of desirable travelers with the demand by other users to serve them in transportation needs, delegating travelers for transporting people and packages from one place to another place and/or for performing tasks in a remote location and paying for services based on peoples' availability, request and response mechanism. Furthermore, the method also embodies real-time travel booking, location based searching, filtering and sorting people along with service reviews, ratings and comments for each.

### CROSS-REFERENCE TO RELATED APPLICATIONS

Not Applicable.

### STATEMENT REGARDING FEDERALLY SPONSORED RESEARCH AND DEVELOPMENT

Not Applicable

### FIELD OF THE INVENTION

This innovation relates to representing people for travel needs and, more particularly, to balancing the supply and demand for people, package and project services in an online people deputation system.

### BACKGROUND ART

There are millions and millions of people travel every day from one place to another place in several means of transport across the world either nationally or internationally for their personal or professional needs. Surprisingly, not everyone knows each other.

On the other hand, there are many people who want to travel different places in the world only if someone accompanies them. Some of the common reasons are they travel for the first time, go to a new place, not aware of travel formalities/procedure, unfamiliar about journey etiquettes/culture of the place, uneasiness due to multiple transits in between the journey, find hard to handle luggage alone or simply can't speak the local language at the time of travel. Unfortunately, every time they are accompanied by their loved ones or beseech known people for travel needs.

Similarly, there are many packages need to be transported to different places in the world only through postal, courier or taken with person, who possess them, with exorbitant cost spent. People don't always prefer to send much needed but low priced items through postal for a charge more than the actual item's worth. Unfortunately, every time the package waits for its possessor or seeks known person to carry and to reach its destination.

Likewise, at least once, every person needs some project done in another place where he/she can't go in person, every time, and get the task done. Predominant reasons are the task is very simple, doesn't require in person visit or needs help from someone to complete. Unfortunately, if the project is of utmost importance, then people travel to the other places spending their time, effort and cost.

All this creates discomfort in people as they wait indefinite for help from someone or plan a trip to get people, package, and/or project done. In the current world, there is no system, method or process trying to address this issue or providing a comprehensive online solution. In most cases, these travelers prefer to do transportation services in their regular travel plan for desirable users as independent travelers who use the revenue obtained through services as a secondary source of income and not as travel commercial agents.

### SUMMARY OF THE INVENTION

This invention has 3 demanding services such as People, Package and Project, making people's travel needs fulfilled by deputizing a trusted person in the internet social networking community. It addresses relating problem by connecting and balancing desirable users and travelers very intelligently and by substituting one another in a trusted community; thereby, drastically curtailing cost, time and effort of people in their travel arrangements.

With the help of this system, TRAVELERs, who want to serve requests, can post their detailed travel plan, either nationally or internationally, or both and publish it to millions of social networking users. Since the system follows a trusted social networking community idea, to authenticate user information, system requests TRAVELERs to provide basic user identification information and validates records to make sure all the information is trustworthy. Once authentication is completed, system takes this information and shows them to users who want a service based on the location TRAVELER resides.

On the other hand, for USERs, who make service requests, system provides an option to find potential TRAVELERs in and around an area using radius map search. Thus, USERs need to provide their identification information for authentication. Upon completion, the system takes this information, shows to TRAVELERs, who can serve those requests based on the location USER resides, and allows TRAVELERs to make one or more service requests to USERs with travel requirements that match desirable user expectations.

Thereby, balancing USERs and TRAVELERs need by initiating service requests and deciding (accept/decline) the offers vice versa. Once any one user accepts the offer, then contact details shall be communicated to each other and pursued to complete the service requested. The system shall also support people profile management, service change management, vehicle ticket booking, status notification, internet escrow services, and comments, review & rating system.

There have been many prior arts which provide a market place where the ability of users to send request and receive response for online transportation information and ticketing system or related services may be bought or sold. For reference: US 20070073562 A1 is issued to Tony Brice, Daniel Delph, George Heil, Ladislav Lettovsky, Joseph Offutt that describes System, method, and computer program product for providing travel information using information obtained from other travelers; U.S. Pat. No. 8,612,273 B2 is issued to Ryan Sven Johnson that describes Method and system for managing vehicle travel; US 20100313152 A1 is issued to Rodney S. Daughtrey, Marty Gardner, Kevin Fox that describes User Interface for Travel Planning; WO 2000062266 A1 is issued to Amir Liberman, Amit Lev-Ari, Tamir Segal, Rafael Lev-Ari that describes Automated on-line matchmaking; U.S. Pat. No. 8,452,624 B2 is issued to Thierry Dufresne, Gilles Chaumont, Cedric Dourthe that describes Online travel reservation system and method delivering restriction-aware travel opportunities; U.S. Pat. No. 9,046,981 B2 is issued to Cheryl Ann Campbell, Erika Marie Rinkleff, Sarah Lynn Devens, Nachiket Prabhakar Katti, David Mark Plante, Tamara K. Blank, Meagan Elizabeth Funches that trip and travel tool; whereas, the present invention introduces a people deputation method to meet peoples' need of transporting person and/or package from a place to another or performing tasks in a remote location by representing travelers is an unique idea. Other features and advantages of the present invention will become apparent from the following more detailed description, taken in conjunction with the accompanying drawings, which illustrate, by way of example, the principles of the invention.

### DESCRIPTION OF THE DRAWINGS

Having thus described the invention in general terms, reference will now be made to the accompanying drawings, which are not necessarily drawn to scale, and wherein:

FIG. 1 is an overall flow of the operation of online people deputation system, according to one embodiment of the invention;

FIG. 2 is an illustration of a user's profile page, in accordance with an embodiment;

FIG. 3 is a block diagram illustrating the components of travel and services of online people deputation system, in accordance with an embodiment of the invention.

FIG. 4 is a block diagram illustrating the components of services management system enabled for users, according to one embodiment of the invention;

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The description provided herein is complete and sufficient for those skilled in the arts of systems and web development to implement the methods as described. One embodiment of this online people deputation system may employ a server running an operating system such as Linux, web-server software such as Apache, and database such as MySQL, with methods implemented through a software development language such as PHP, MVC or Java. However, the invention should not be limited to the types of software operating system, web-server software, database software, software development language, server or client hardware.

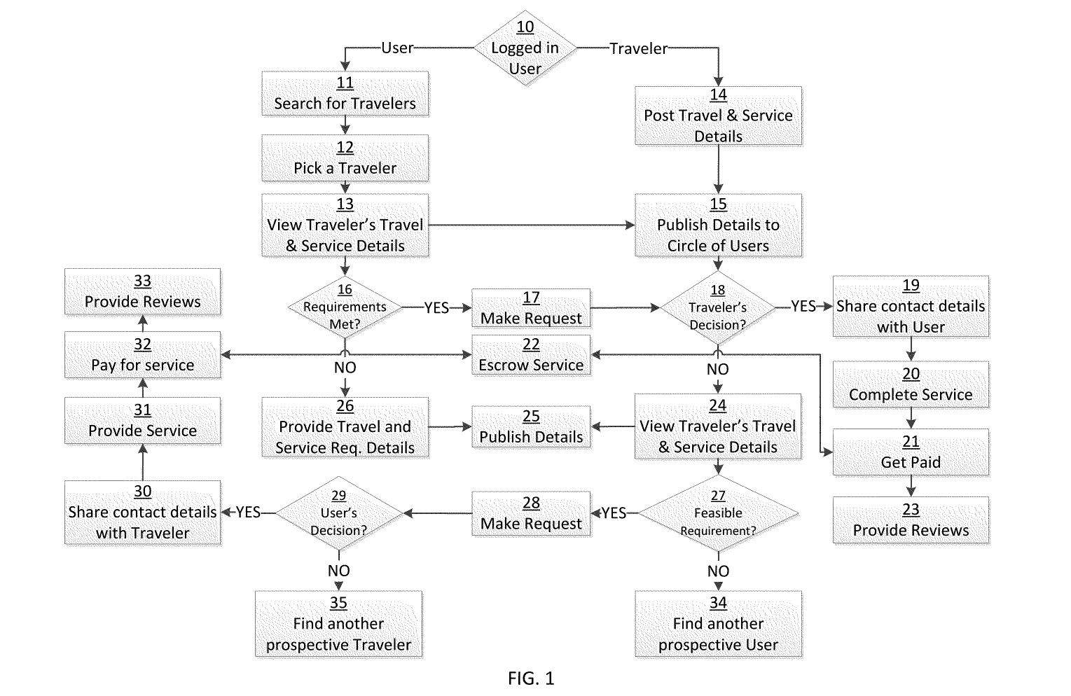

FIG. 1 is an overall flow of the operation of online people deputation system, according to one embodiment of the invention. The method adopted in the system facilitates users to register themselves by providing basic information such as First Name, Last Name, DOB, Email ID, and Mobile No. Once registered, users shall login 10 to the system by providing User Name & Password and verifying their email ID, mobile number and Identification proof to authorize. User shall search for travelers 11 who meet user's service needs such as people, package and project. The system displays a list of travelers who closely matches the expectations of users. The user shall be given option to pick a traveler 12 and view travel details of the user 13 along with service information that traveler wishes to perform in his/her travel. Here, travelers shall post complete details 14 of their travel plan with specific service information such as people, package and project. They shall publish travel details 15 to a circle of users imported from their social networking applications so that requests shall be visible only to that group. When a user finds a traveler's travel & service details are feasible 16, then he/she shall make a request 17 to traveler to serve on his/her needs. The system sends that request to traveler 18 and asks traveler to respond to user. If traveler accepts the request, then person's contact details shall be communicated to each other 19 and to further accomplish the service. The traveler works on service request and completes service 20 per user's expectations. Once traveler completes the service, he/she shall be paid the compensation 21 from user through Escrow payment service. The system implements Escrow payment service 22 to debit money from user's account, temporarily holds it in system's account and transfers it to traveler only after the completion of service. The system also obtains reviews, ratings and comments 23 from both user and traveler, publishes them in individual's profile for future services and closes the service and transaction.

On the other hand, if the traveler declines a service request, still he/she can search for users who have provided their need for travel and service information 26 that closely matches the requirements of traveler. The traveler shall check the feasibility 27 of user's requirements published and make a request to serve 28. The system takes this request and displays it to user in their profile page so that user shall see complete list of travelers, who have shown interest to work on his/her service request. Here, user shall pick a traveler who matches travel and service requirement and respond by accepting the request 29 so that contact details of both parties shall be shared 30 with each other and processed further for service completion 31. Once user acknowledges the completion of service, his/her account shall be debited with the service charge and paid to traveler through Escrow payment service 22. The system also obtains reviews, ratings and comments 33 from both user and traveler, publishes them in individual's profile for future services and closes the service and transaction. In case, the traveler declines 34 or doesn't respond to user's service request, then system balances the surplus and deficit by matching other available user profiles that meet traveler's expectation. Similarly, if user declines 35 or doesn't respond to traveler's service request, then system balances the surplus and deficit by matching other available traveler profiles that meets user's expectation.

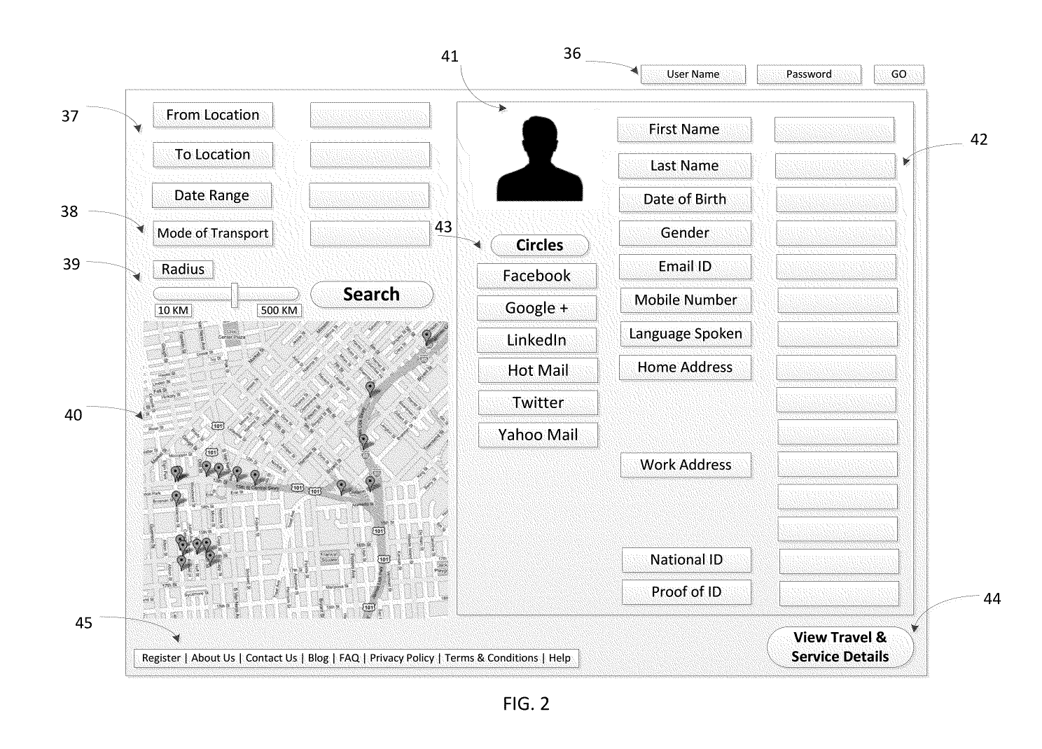

FIG. 2 is an illustration of a user's profile page, in accordance with an embodiment. The method adopted in the system facilitates users to login to the system 36 using User Name and Password. The user finds option to search for travelers or traveler finds option to search for users by providing From Location, To Location and Date Range details 37 and by selecting mode of transport 38 such as Flight, Cruise, Train, Bus and Car. Upon keying all required fields, system performs radius search 39 from a given area. For this, system invokes google maps API 40 to show list of available users/travelers in map marker. The system lets users to select one and view details except contact information. A view of photograph of user 41 is provided along with personal details 42 such as First Name, Last Name, Date of Birth, Gender, Email ID, Mobile Number, Language Spoken, Home and Work Addresses. With those details users shall check basic information about traveler and also his/her social networking circle 43 details from sites such as Facebook, Google+, LinkedIn, Hot Mail, Twitter and Yahoo mail. Based on the details provided, user shall choose to view service details such as people, package and project of travelers by clicking “View Travel & Service Details” 44. All the users/travelers who log in or don't log in shall see information directory 45 such as Register, About Us, Contact US, Blogs, FAQ, Privacy Policy, Terms & Conditions and Help to know additional details about working of the system.

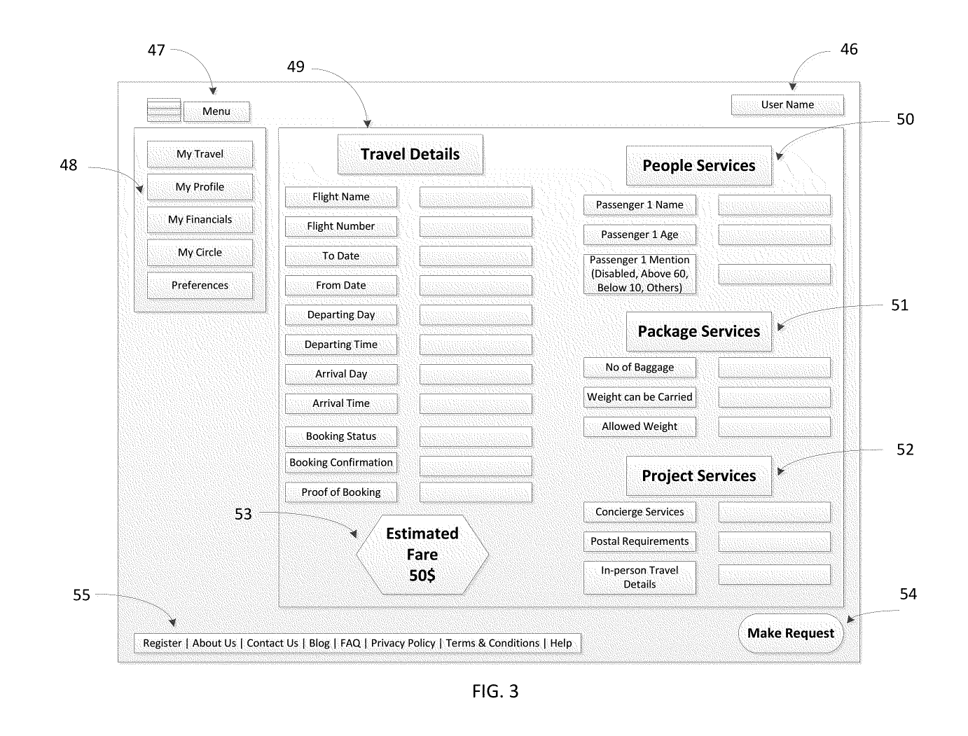

FIG. 3 is a block diagram illustrating the components of travel and services of online people deputation system, in accordance with an embodiment of the invention. The method adopted in the online people deputation system facilitates general user to create profile and login 46. The system guides user to view menu options 47 such as My Travel, My Profile, My Financials, My Circle and Preferences. Upon selection of each option, the system displays logged in user specific information 48. From action 44, the user/traveler shall view basic information of the prospect and click to view travel & service details posted.

The system provides complete travel details 49 of prospect such as Flight Name, Flight Number, From and To Dates, Departing Day, Departing Time, Arrival Day, Arrival Time, Booking Status, Booking Confirmation and Proof of Booking. For example, if a traveler has shared his/her travel information from New York, USA to Frankfort, Germany on Jan. 1, 2016 in American Airlines. Then the user shall see Flight Name: American Airlines; Flight Number: 2158; From Date: 1 Jan. 2016; To Date: 2 Jan. 2016; and system's auto populated details such as Departing Day: Friday, Jan. 1, 2016; Departing Time: 04:20 EST; Arrival Day: Saturday, Jan. 2, 2016; Arrival Time: 18:10 CEST along with user supplied details such as Booking Status: Confirmed; Booking Confirmation: Email; and Proof of Booking: A confirmation proof email. Similarly, in the case of users, they shall share their travel need in the system by providing airline information, from and to location and date range so that any traveler can search and pick the prospect.

In another embodiment of the present invention, the system also displays all service information that a traveler or user is enrolled for. For people services 50, system shows other travelling passengers information such as Passenger First Name, Passenger Last Name, Passenger Age, Passenger Gender and Any other conditions of Passenger such as below 10 age, above 60 age and Physically Challenged etc. Similarly, in the case of users, they shall share their people service need in the system by providing number of people to be accompanied and their personal information so that any traveler can search and make best choice before raising service request.

For Package services 51, system shows package information such as Number of Baggage Carried, Weight can be Carried and Allowed Weight in the Vehicle. For example, Number of Baggage Carried: 2; Weight can be carried: 10 KG; and Allowed Weight in the Vehicle: 50 Kg. Similarly, in the case of users, they shall share their package service need in the system by providing weight needs to be carried, individual items, complying the laws and baggage regulations of the country the package travels, dimension of the package etc. so that any traveler can search and express interest to serve.

For Project services 52, system shows project information such as Concierge Services, Postal Requirements, and In-Person Travel Requirement. For example, Concierge Service: Need to collect letter from Government Agency; Postal Requirements: NO; and In-Person Travel Requirements: YES. Similarly, in the case of users, they shall share their project service need in the system by providing exact concierge service details, and travel requirement information so that any traveler can search and send service request to serve.

In another embodiment of the present invention, the system also provides estimates for each service 53 so that user shall make a well informed decision before making the request. Once user finds all feasibility in travel and service details posted by the traveler, then user proceeds to make request 54. All the users/travelers shall see information directory 55 such as Register, About Us, Contact US, Blogs, FAQ, Privacy Policy, Terms & Conditions and Help to know additional details about various individual services.

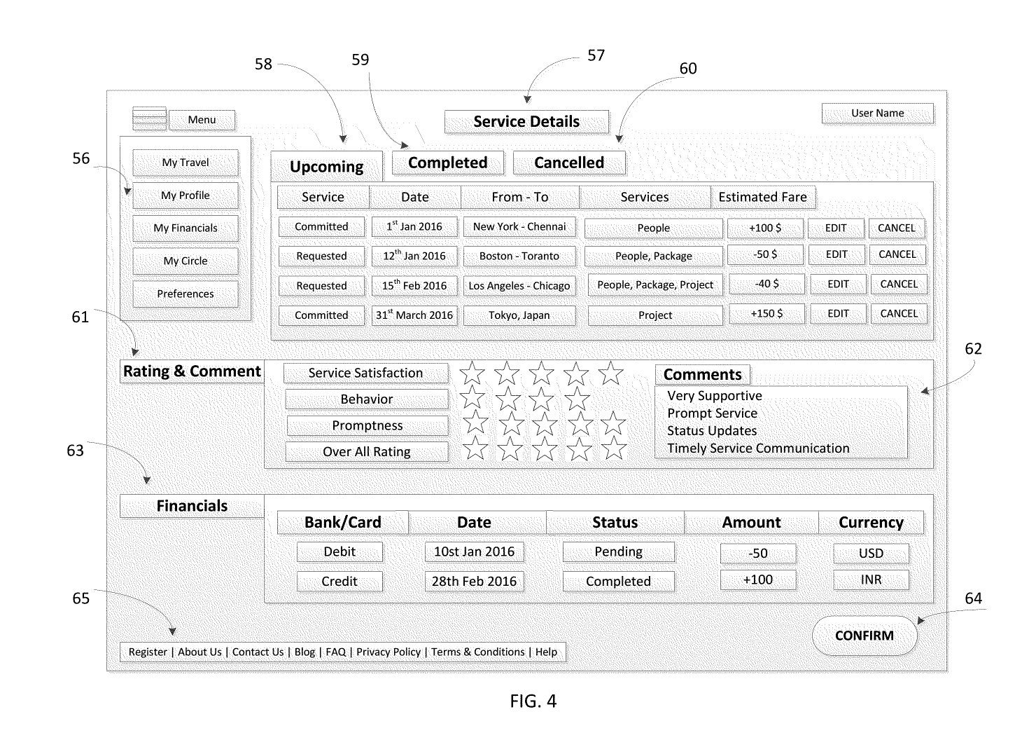

FIG. 4 is a block diagram illustrating the components of services management system enabled for users, according to one embodiment of the invention. The method adopted in the online people deputation system facilitates users and travelers to manage services, financials, and reviews & ratings under drop down menu option 56. The users/travelers shall be able to view service details 57 such as Upcoming, Completed, and Cancelled. Under upcoming tab 58, users/travelers shall see all future planned travel and accepted services information along with estimated rates and options to edit and/or cancel confirmed service requests. Upon modifying the accepted service request, the system provides revised estimates which need to be agreed mutually by both parties. Under Completed tab 59, users/travelers shall see all completed services details and confirmed cost associated with each transaction. Under Cancelled tab 60, users/travelers shall see all cancelled services details and any penalty cost associated with each transaction.

In another embodiment of the present invention, for each service and transaction, user/traveler shall be reviewed, rated and commented 61. Each scalable features of service is rated for 5 star based on which overall rating shall be reckoned and displayed in public view at the time of users/travelers search. Similarly, at the end of each service, user and traveler can provide comments 62 on their experience with each other. All these comments shall be made available in individual user's profile, which helps system users to know more about the person and determine feasibility. In yet another embodiment of the present invention, users may be asked to provide answers to specific feedback or review questions, or to write and answer any feedback or review questions they may provide. To further prevent abuse, the user who is reviewed may be given the opportunity to respond to any negative feedback by providing an explanation or rebuttal.

The financials section of the system 63 shows complete financial information of all committed or serviced transactions. Various information in this section provides individual debited and credited bank records, and it also provide overall payment details in transacted currencies respectively. The system allows users/travelers to makes changes to their financials and apply them in bank account by clicking CONFIRM button 64. All the users/travelers shall see information directory 65 such as Register, About Us, Contact US, Blogs, FAQ, Privacy Policy, Terms & Conditions and Help to know additional details about service management options.

While a particular form of the invention has been illustrated and described, it will be apparent that various modifications can be made without departing from the spirit and scope of the invention. Accordingly, it is not intended that the invention be limited, except as by the appended claims.

1. A method of transporting people and packages and getting tasks done anywhere by deputizing people for travel needs through an online people deputation portal, the method comprises of:
a. User searching people who can cater transportation services,
b. User sending request with an fixed pay offer to travelers for service,
c. Traveler responding either accept, or reject, said offer to user; and
d. System allowing the two users to communicate only after said offer is accepted.

2. The computer implemented method according to claim 1 is configured to enable users to register in the online people deputation system as users, who make service requests, and as travelers, who serve user's request.

3. The computer implemented method according to claim 1 is further configured to manage user's profile and verify identification before raising transport service requests.

4. The computer implemented method according to claim 1 comprises of radius searching people in a particular area so that desirable user can see list of all travelers in a data range.

5. The computer implemented method according to claim 1 comprises of storing travel mode such as flight/cruise/train/bus/car and details along with people, package and project service information.

6. The computer implemented method according to claim 5 further comprising, in people service, transportation requirement of picking persons from any accessible location and dropping them to another location is provided.

7. The computer implemented method according to claim 5 further comprising, in package service, transportation requirement of sending parcels/items from any accessible location and delivering them to another location is provided.

8. The computer implemented method according to claim 5 further comprising, in project service, performing concierge services in any accessible remote location from user's locations with or without travel requirement is provided.

9. The computer implemented method according to claim 1 comprising, publishing the details to preferred group of users such as friends, acquaintances, and/or unknown per user preferences.

10. The computer implemented method according to claim 1 comprising, verifying identity and travel details of travelers for authorization before picking a traveler.

11. The computer implemented method according to claim 1 in which desirable users are shown an estimated charge that they need to pay travelers for services.

12. The computer implemented method according to claim 1 comprising, checking the availability of travelers in their travel calendar and making service requests.

13. The computer implemented method according to claim 1 comprising, system transmitting the request and awaiting reply within a stipulated time.

14. The computer implemented method according to claim 1 comprising, traveler checking the details of user and service requested and determining the feasibility of catering the service.

15. The computer implemented method according to claim 1 in which traveler accepting or declining request and responding back to desirable user.

16. The computer implemented method according to claim 1 in which if traveler not responding in a stipulated time to a request, then system automatically cancelling the request and showing other feasible prospects to the user.

17. The computer implemented method according to claim 1 in which the communication details of both are exchanged only if request is accepted by traveler.

18. The computer implemented method according to claim 1 comprising, users posting their transportation requirements and specific services, which allow travelers to make well informed decision on the requests.

19. The computer implemented method according to claim 1 comprising, travelers making request to users whose service requirements closely matches with their catering feasibility.

20. The computer implemented method according to claim 1 in which user accepting or declining request and responding back to traveler.

21. The computer implemented method according to claim 1 in which communication details of both are exchanged only if request is accepted by user.

22. A computer implemented system, comprising:
a. A review and rating system for each user
b. Online transportation availability check and reservation system
c. Service status communication system
d. Rewards and promotion codes management system

23. The computer implemented method according to claim 22 in which both users providing star rate to each other about the service granted and offered respectively.

24. The computer implemented method according to claim 22 comprising, managing and displaying reviews and ratings of travelers posted by others and vice versa.

25. The computer implemented method according to claim 22 comprising, users or travelers editing the service request in concurrence with other so that estimated fare gets revised accordingly.

26. The computer implemented method according to claim 22 comprising, user or traveler getting percentage of refund depends on timeline of cancellation.

27. The computer implemented method according to claim 22 comprising, users checking the fare and status of the transport so that feasibility comparison can be made before making service request.

28. The computer implemented method according to claim 22 comprising, users making reservation in the transport by formal booking process.

29. The computer implemented method according to claim 22 in which system providing the up to date status of transport to users before, during and after the service.

30. The computer implemented method according to claim 22 comprising, travelers updating the status of the service manually for transports for which auto status check is not applicable.

31. The computer implemented method according to claim 22 comprising, users getting rewards and promotion codes for the service they consume from the system.

32. The computer implemented method according to claim 22 in which users, whose service star ratings and reviews are higher, get additional discounts and rewards that can be used for next services.

33. The computer implemented method according to claim 1 is further configured to facilitate payment of compensation through an escrow service.

34. The computer implemented method according to claim 1 comprising, highly secured payment gateway configuration system to manage users' monetary transactions.

35. The computer implemented method according to claim 1 comprising, a reliable SMS notification system for services and user profile setup management.

36. The computer implemented method according to claim 1 is configured to specify terms and conditions of the services.

37. The computer implemented method according to claim 1 is further configured to enable negotiation of terms and conditions of the services.
